(19) United States
(12) Patent Application Publication
(10) Pub. No.: US 2017/0093539 A1
(43) Pub. Date: Mar. 30, 2017

(54) BEAMFORMING CALIBRATION

(71) Applicant: Space Systems/Loral, LLC, Palo Alto, CA (US)

(72) Inventor: Leah Wang, Fremont, CA (US)

(21) Appl. No.: 14/865,774

(22) Filed: Sep. 25, 2015

(51) Int. Cl. H04L 5/00; H04B 7/185; H04W 72/04

(52) U.S. Cl. CPC H04L 5/0048; H04W 72/046; H04W 72/0406; H04B 7/18506

(57) ABSTRACT

This disclosure provides systems, methods and apparatus for determining beamforming coefficients. In one aspect, a subsystem of a satellite can receive live-traffic signals and tap the signals to provide reference signals. The reference signals can be provided on a calibration path including passive components. The signals can be compared with the reference signals to determine differences between the phases and amplitudes and used to determine beamforming coefficients.

### TECHNICAL FIELD

This disclosure relates generally to beamforming, and more particularly to a calibration system for determining beamforming coefficients used to adjust a signal's phase and amplitude to form a beam.

### BACKGROUND

Spacecraft for communications and broadcast services operating in, for example, geosynchronous orbit may communicate to a ground device by using a phased array antenna and generating a forward user downlink signal for reception on the ground device (or user terminal) associated with a user. In return, the user can transmit back a return user uplink signal via the ground device to the spacecraft. Beamforming is a technique in which the phased array antenna is configured to position the forward user downlink signal to increase data capacity at a specific location of the ground device.

Beamforming coefficients can be used to adjust the forward user downlink signal's phases and amplitudes at the multi-feed transmitter of the phased array antenna to steer the user beam to a specific location. However, determining the beamforming coefficients often involves dedicated calibration circuitry and a dedicated calibration signal. Using a dedicated calibration signal can reduce the communication traffic -capacity of the spacecraft. Additionally, dedicated calibration circuitry using a dedicated calibration signal is likely to use active components with active bandwidth. As the spacecraft ages (e.g., over a 15-year lifetime), the active components of the calibration circuitry can degrade over time, resulting in imprecise coefficients for beamforming.

Thus, an improved system for determining beamforming coefficients is desired.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus comprising a spacecraft communications subsystem including a channelizer; a set of input components configured to provide a plurality of return user uplink signals to the channelizer, each of the set of input components including a corresponding test coupler configured to provide reference return user uplink signals; an input switch configured to receive each of the reference return user uplink signals; a set of output components configured to receive a plurality of forward user downlink signals from the channelizer, each of the output components including a corresponding test coupler configured to provide reference forward user downlink signals; an output switch configured to receive each of the reference forward user downlink signals; and a multiplexer having a first input to receive a feeder link signal, a second input to receive one of the reference return user uplink signals from the input switch as a selected reference return user uplink signal, a third input to receive one of the reference forward user downlink signals from the output switch as a selected reference forward user downlink signal, and an output providing the feeder link signal, the selected return user uplink signal, and the selected reference forward user downlink signal to the channelizer, wherein the channelizer is configured to determine amplitude and phase offsets of the selected reference return user uplink signal with the corresponding return user uplink signal, and determine amplitude and phase offsets of the selected reference forward user downlink signal with the corresponding forward user downlink signal.

In some implementations, each of the forward user downlink and the return user uplink signals are live traffic signals to and from ground devices, respectively.

In some implementations, the channelizer includes inputs to receive the return user uplink signals and outputs to provide the forward user downlink signals, and the channelizer is further configured to determine amplitude and phase offsets for each path between the inputs and the outputs.

In some implementations, the spacecraft communications subsystem is configured to transmit the amplitude and phase offsets to a control station, and wherein the spacecraft communications subsystem is configured to receive corresponding beamforming coefficients from the control station for adjusting phases and amplitudes of signals generated at the outputs of the channelizer.

In some implementations, the feeder link signal, the selected reference return user uplink signal, and the selected reference forward user downlink signal are associated with separate frequency bands.

In some implementations, the separate frequency bands are non-overlapping.

In some implementations, each component in calibration paths providing the reference forward user downlink signals and the reference forward user downlink signal is passive.

In some implementations, the set of input components and the set of output components include active components.

In some implementations, the input switch and the output switch are electromechanical switches.

In some implementations, the channelizer is further configured to configure the input switch to provide each of the reference return user link signals to the multiplexer and the output switch to provide each of the reference forward user link signals to the multiplexer, the signals provided to the multiplexer in pairs, each pair including one signal provided by the input switch and one signal provided by the output switch.

Another innovative aspect of the subject matter described in this disclosure can be implemented in a digital channelizer of a spacecraft communications subsystem, the digital channelizer being configured to determine phase and amplitude differences of a return user uplink signal with a corresponding reference user uplink signal, and phase and amplitude differences of a forward user downlink signal with a corresponding reference forward user downlink signal, the digital channelizer being further configured to receive the reference user uplink signal and the reference forward user downlink signal frequency-division multiplexed with a forward feeder link signal.

In some implementations, the forward user downlink signal and the return user uplink signal are live traffic signals to and from ground devices, respectively.

In some implementations, the digital channelizer is further configured to determine amplitude and phase differences of signals for each path between its inputs and outputs.

In some implementations, the amplitude and phase differences are used to determine beamforming coefficients for signals generated at outputs of the digital channelizer.

In some implementations, the forward feeder link signal, the reference return user uplink signal, and the reference forward user downlink signal are associated with separate frequency bands.

In some implementations, the separate frequency bands are non-overlapping.

In some implementations, the digital channelizer is further configured to select the reference forward user downlink signal and the reference return user uplink signal to be frequency-division multiplexed with the forward feeder link signal.

Another innovative aspect of the subject matter described in this disclosure can be implemented in a method comprising selecting, by a spacecraft communications subsystem, a reference return user uplink signal corresponding to a return user uplink signal, the reference return user uplink signal provided on a first calibration path having passive components, the return user uplink signal provided on an input path having active components; selecting, by the spacecraft communications subsystem, a reference forward user downlink signal corresponding to a forward user downlink signal, the reference forward user downlink signal provided on a second calibration path having passive components, the forward user downlink signal provided on an input path having active components; multiplexing, by the spacecraft communications subsystem, the reference return user uplink signal and the reference forward user downlink signal with a forward feeder uplink signal such that the reference return user uplink signal, the reference forward user downlink signal, and the forward feeder uplink signal are in separate frequency bands; and determining, by the spacecraft communications subsystem, phase and amplitude offsets between the multiplexed reference return user uplink signal and the return user uplink signal, and phase and amplitude offsets between the multiplexed reference forward user downlink signal and the forward user downlink signal.

In some implementations, the method can comprise transmitting, by the spacecraft communications subsystem, the phase and amplitude offsets; receiving, by the spacecraft communications subsystem, beamforming coefficients corresponding to the phase and amplitude offsets; and generating, by the spacecraft communications subsystem, a second forward user downlink signal with a phase and an amplitude based on the beamforming coefficients.

In some implementations, the spacecraft communications subsystem includes a channelizer having an input to receive the return user uplink signal, an output to provide the forward user downlink signal, and a feeder input to receive the multiplexed reference return user uplink signal, the reference forward user downlink signal, and the forward feeder uplink signal.

### BRIEF DESCRIPTION OF THE DRAWINGS

The included drawings are for illustrative purposes and serve only to provide examples. These drawings in no way limit any changes in form and detail that may be made by one skilled in the art without departing from the spirit and scope of the disclosed embodiments.

FIG. 1 is an example of a satellite communications network.

FIG. 2 is a simplified block diagram of an example of a spacecraft communications subsystem with beamforming capability.

FIG. 3 illustrates an example of a beamforming calibration system utilizing live traffic signals that is integrated to the payload system through multiplexers where calibration signals are frequency multiplexed with other signals and routed together.

FIG. 4 is an example of a flowchart for determining beamforming coefficients.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the disclosed subject matter, as defined by the appended claims.

### DETAILED DESCRIPTION

Specific exemplary embodiments will now be described with reference to the accompanying drawings. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “connected” or “coupled” to another element, it can be directly connected or coupled to the other element, or intervening elements may be present. It will be understood that although the terms “first” and “second” are used herein to describe various elements, these elements should not be limited by these terms. These terms are used only to distinguish one element from another element. As used herein, the term “and/or” includes any and all combinations of one or more of the associated listed items. The symbol “/” is also used as a shorthand notation for “and/or”.

The terms “spacecraft”, “satellite” may be used interchangeably herein, and generally refer to any orbiting satellite or spacecraft system.

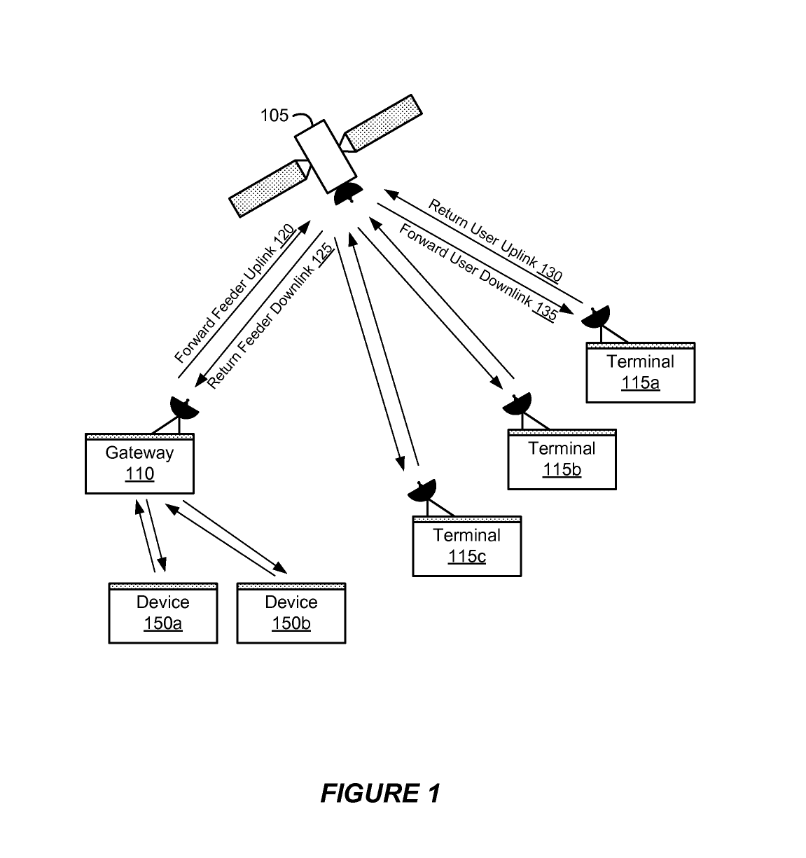

FIG. 1 is an example of a satellite communications network. The satellite communications network in FIG. 1 includes satellite 105 at an orbital location and communicating with gateway 110 and a population of user terminals 115a-c. Gateway 110 can be a base or land Earth station providing communication between the satellite and other networks or communication systems, such as public switched telephone networks, the Internet, etc. User terminals 115a-c can be user devices (e.g., phones, tablets, laptops, transportation vehicles such as airplanes, cars, trains, ships, etc.). User terminals 115a-c can communicate with each other via satellite 105. Additionally, user terminals 115a-c can communicate with each other via satellite 105 and gateway 110. User terminals 115a-c can also communicate with other devices 150a and 150b via satellite 105 and gateway 110 (e.g., devices on the network that gateway 110 interfaces with, such as the Internet).

Generally, gateway 110 can provide forward feeder uplink signal 120 to satellite 105 and receive return feeder downlink signal 125 from satellite 105. For example, satellite 105 can include a feeder link antenna configured to communicate with gateway 110 Likewise, user terminal 115a can provide return user uplink signal 130 to satellite 105 and receive forward user downlink signal 135. For example, satellite 105 can include a user link antenna configured to communicate with user terminal 115a. User terminals 115b and 115c can also provide and receive similar types of signals as user terminal 115a. Accordingly, signals can be provided among the components of the satellite communications network in FIG. 1 such that different user terminals, gateways, and other devices can receive and send data to each other.

Beamforming is a technique in which forward user downlink signal 135 is adjusted by satellite 105 by using beamforming coefficients to form a narrow spot beam to increase the data capacity of a signal at a position on Earth. For example, beamforming coefficients can be used by satellite 105 to form a narrow spot beam to forward user downlink signal 135 to user terminals 115a.

In the absence of the presently disclosed techniques, a dedicated calibration signal generated by dedicated calibration circuitry can be used to determine the beamforming coefficients of the multi-feed transmitter for forward user downlink signal 135. However, using a dedicated calibration signal can result in a reduction in the communication traffic capability of satellite 105. Additionally, the dedicated calibration circuitry is often implemented using active components that can degrade over time. For example, as satellite 105 ages over its lifetime, the active components of the dedicated calibration can similarly age over time and degrade, resulting in an imprecise determination of the beamforming coefficients.

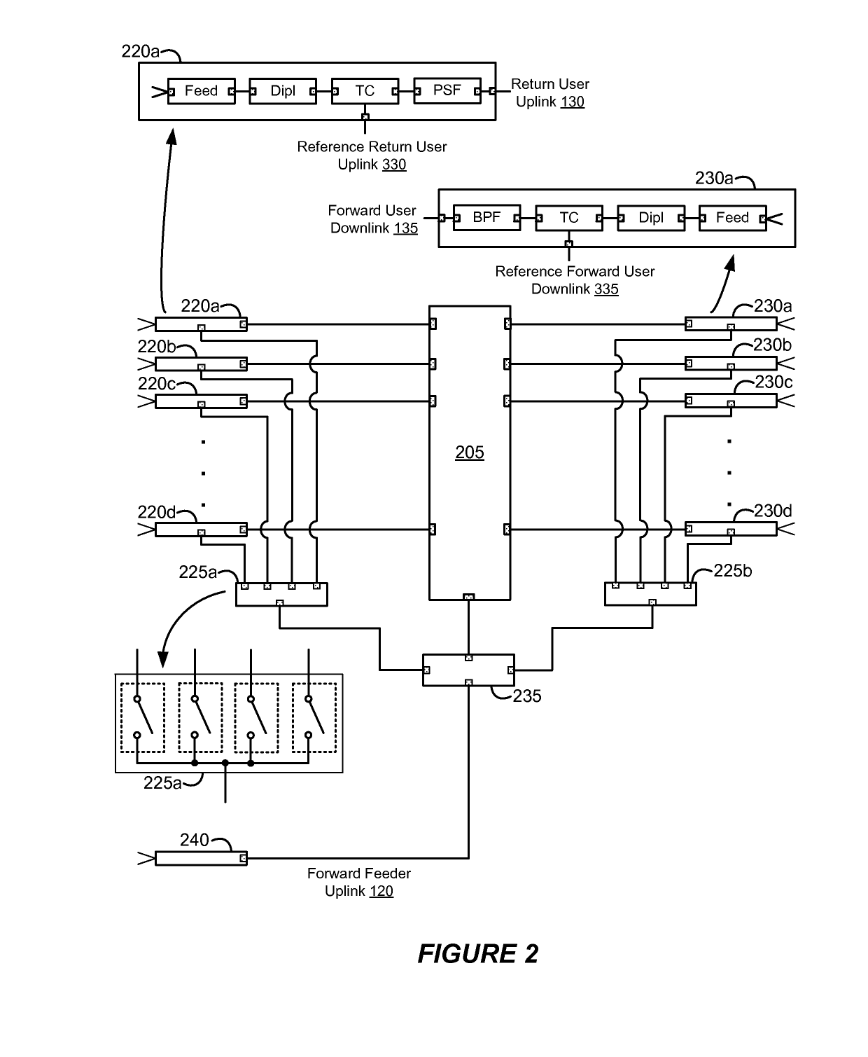

FIG. 2 is a simplified block diagram of portions of a satellite communications subsystem that includes a beamforming calibration capability that can be implemented as a subsystem of satellite 105. As described hereinbelow the subsystem may be configured to determine the beamforming coefficients without a dedicated calibration signal, resulting in satellite 105 having increased communication traffic capability. For example, the subsystem may be configured to tap and use existing live traffic signals (e.g., signals uplinked from Earth from ground devices, such as return user uplink signal 130, and signals downlinked to earth, such as forward user downlink signal 135) as calibration signals to determine the beamforming coefficients. Advantageously, the beamforming calibration capability may be implemented using a calibration path having passive components (e.g., electromechanical devices such as switches, or devices such as tap couplers, multiplexers, etc.) rather than active components (e.g., diodes, transistors, low noise amplifiers, frequency converters, etc.), and therefore, can provide a more accurate determination of the beamforming coefficients as satellite 105 ages. Moreover, relative to conventional techniques the presently disclosed beamforming calibration techniques may reduce the number of components for determining beamforming coefficients, and therefore, provide a reduction in cost.

In some implementations, the beamforming calibration is performed by “tapping” live traffic signals such as return user uplink signal 130 and forward user downlink signal 135 to provide corresponding tapped reference signals. The tapped reference signals can be frequency-division multiplexed (FDM) by a multiplexer (e.g., multiplexer 235 in FIG. 2) along with forward feeder uplink signal 120, which may all be within separate and non-overlapping frequency bands, and provided to an input of channelizer 205 that is generally used to receive forward feeder uplink signal 120. Channelizer 205 can determine offsets by comparing return user uplink signal 130 and forward user downlink signal 135 with their corresponding tapped reference signals to determine differences in the phases and amplitudes of the signals and generate the offsets representing the differences. Additionally, channelizer 205 can determine phase and amplitude offsets for signals being routed internally (e.g., from an input of a channelizer to an output of the channelizer). As a result, phase and amplitude offsets can be determined for every input path, internal paths within channelizer 205, and output path. The offsets can be used to determine beamforming coefficients. For example, the offsets can be downlinked to a ground or control station to determine the beamforming coefficients based on the offsets determined by satellite 105. The ground station can then uplink the calculated beamforming coefficients to satellite 105. The beamforming coefficients may then be used by channelizer 205 by adjusting the phases and amplitudes of the beamforming multi-feed transmitter of the forward user downlink signals 135 provided at the outputs of channelizer 205 such that forward user downlink signals 135 are beamformed. Accordingly, rather than using a dedicated calibration signal, live traffic signals (e.g., return user uplink signal 130 from user terminal 115a, as well as similar signals from user terminals 115b,115c, etc.) can be used to calibrate and determine the beamforming coefficients by determining phase and amplitude offsets. Additionally, the disclosed techniques minimize use of active components and require fewer components than conventional techniques.

In more detail, in FIG. 2, channelizer 205 can be a digital channelizer implemented with a circuit such as a digital signal processor (DSP) (or other type of semiconductor device or circuitry, such as a microprocessor, microcontroller, field-programmable gate array (FPGA), etc.) that receives signals (or data) at inputs, processes the signals, and provides signals (or data) at its outputs.

Satellite 105 can include a collection of signal input modules 220a-d at a receive (or input) stage and a collection of signal output modules 230a-d at an output (or transmit) stage. Signal input modules 220a-d receive return user uplink signals 130 from user terminals such as user terminals 115a-c as live-traffic signals (i.e., actual signals being provided during normal operation of satellite 105 and its communications network), process the signals, and provide the signals to channelizer 205. Channelizer 205 can process the signals and route the signals to specific outputs and provide the signals to signal output modules 230a-d of the output stage, which can perform additional processing for transmission of forward user downlink signals 135. In some implementations, additional circuitry may exist between the outputs of signal input modules 220a-d and the inputs of channelizer 205, as well as the outputs of channelizer 205 and the inputs of signal output modules 230a-d.

In FIG. 2, signal input module 220a includes a feed as part of an antenna for receiving return user uplink signal 130 from user terminal 115a picked up by a reflector of the antenna. A diplexer (Dipl) can then filter the signal received by the antenna feed and provide it to a test coupler (TC). The TC can provide a tap of return user uplink signal 130 and provide it to switch 225a as a reference signal of return user uplink signal 130 (i.e., a reference return user uplink signal) that can be used to calibrate the beamforming coefficients, as discussed later herein. Signal input module 220a also includes a preselect filter (PSF) to further filter return user uplink signal 130 to provide a particular frequency band to channelizer 205. Accordingly, channelizer 205 can receive return user uplink signal 130, perform additional processing, and forward the processed signal to one of its outputs, which is provided to one of signal output modules 230a-d. As depicted in FIG. 2, signal output module 230a includes a bandpass filter (BPF) to filter the signal received from channelizer 205, a test coupler, a diplexer, and feeds used to transmit the signal using a corresponding antenna as forward user downlink signal 135. The test coupler of signal output modules 230a-d also provide a tap to provide reference forward user downlink signals, as discussed later herein.

Additionally, the subsystem of FIG. 2 includes feeder signal input module 240, which includes some similar functionality as signal input modules 220a-d, but is configured to pick up forward feeder uplink signal 120 from gateway 110.

The input paths from the antenna feeds of signal input modules 220a-d to inputs of channelizer 205 and the output paths from outputs of channelizer 205 to the antenna feeds of signal output modules 230a-d can degrade over time due to having active components. For example, forward user downlink signal 135 received at the antenna feed of signal input module 220a may differ (e.g., have a different phase and amplitude) from the same signal by the time it is received at the input of channelizer 205 due to the input path having active components. Likewise, forward user downlink 135 provided at an output of channelizer 205 may differ from the same signal at the antenna feed of the signal output module 230a-d it is transmitted from. Beamforming coefficients can be used to account for these deviations when channelizer 205 generates signals at its outputs and improve the data capacity of the satellite communication subsystem, as discussed later herein. For example, the beamforming coefficients can be derived by tapping the signals to provide reference signals that use calibration paths with passive components rather than active components, and therefore, the signals can be compared with their reference signals to determine how they differ.

In particular, switch 225a, switch 225b, and multiplexer 235 can be used by the subsystem of FIG. 2 to calibrate beamforming coefficients by providing a calibration path for the tapped reference signals that can be used by channelizer 205 to determine differences between the phases and amplitudes of the tapped reference signals with the signals they are tapped from as offsets. The offsets can be used to determine beamforming coefficients that can be applied to signals (e.g., forward user downlink 135) to modify their phases and amplitudes to take into account the differences.

Switches 225a and 225b can be electromechanical switches that provide one of their inputs to their outputs. For example, if the subsystem of FIG. 2 includes 120 signal input modules at its receive stage, then 120 taps from the corresponding test couplers of the 120 signal input modules can provide 120 reference return user uplink signals to switch 225a, which would be a 120-to-1 switch (i.e., receiving 120 inputs and providing 1 of those 120 inputs as an output). Likewise, if the subsystem of FIG. 2 includes 120 signal output modules at its output stage, then 120 taps from the corresponding test couplers of the 120 signal output modules can provide 120 reference forward downlink signals to switch 225b, which would also be a 120-to-1 switch.

Switches 225a and 225b can switch in unison (at a similar rate or frequency) to provide a pair of reference return user uplink signal and 120 reference forward downlink signal to multiplexer 235. For example, switch 225a can select the reference return user uplink signal from signal input module 220a and switch 225 can select the reference forward downlink signal to be provided to signal output module 230a to be provided to multiplexer 235. Next, switches 225a and 225b can both change the configurations of their switching such that the reference signals of signal input module 220b and signal output module 230b are selected to be provided to multiplexer 235. Switches 225a and 225b can switch through each pair of signal input modules and signal output modules. For example, if there are 120 of the pairs, then switches 225a and 225b may switch through each of the 120 pairs when calibrating beamforming coefficients. In some implementations, channelizer 205 can provide the signals to instruct switches 225a and 225 to change their configurations to provide different inputs to their outputs. For example, when channelizer 205 has determined the offsets associated with the pair, it may subsequently instruct switches 225a and 225b to switch to the next pair so that channelizer 205 can then determine offsets related to that pair.

Multiplexer 235 can be a device to perform frequency-division multiplexing to allow for the signals provided by switch 225a, switch 225b, and feeder signal input module 240 to be on the same medium (e.g., cable, wire, etc.), but at different frequency bands. Providing each of the signals to the same input port of channelizer 205 can allow for the communication traffic capability of satellite 105 to be higher than if the reference signals were provided to their own input ports of channelizer 205 since less input ports would be available for live traffic signals.

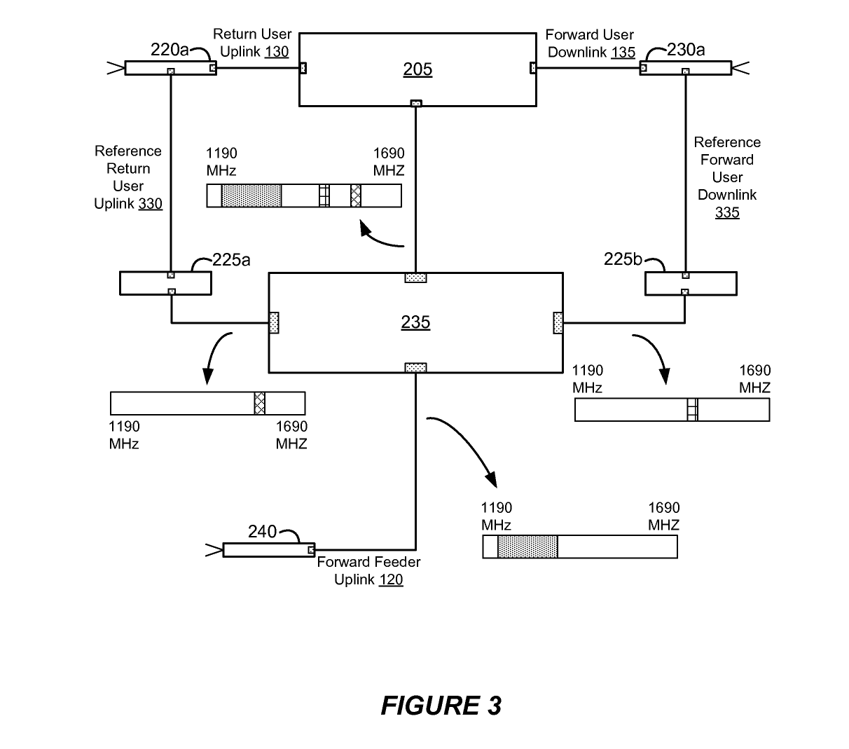

FIG. 3 illustrates additional details of a portion of the spacecraft communications subsystem illustrated in FIG. 2. More particularly, it is shown that multiplexer 235 may provide an output with signals at different frequency bands. In the example of FIG. 3, reference signals of return user uplink signal 130 and forward user downlink signal 135 of signal input module 220a and output signal module 230a, respectively, are selected by switches 225a and 225b to provide the corresponding reference signals to multiplexer 235. Additionally, forward feeder uplink signal 120 from feeder signal input module 240 is also provided to multiplexer 235.

Forward feeder uplink signal 120, return user uplink signal 130 (and its corresponding reference signal, return user uplink signal 330), and forward user downlink signal 135 (and its corresponding reference signal, reference forward user downlink signal 335) can operate within separate and non-overlapping frequency ranges, or bands, and therefore, can be multiplexed by multiplexer 235 to be provided on the same input to channelizer 205. For example, in FIG. 3, feeder uplink signal 120 can operate within a 150 MHz band between 1190 MHz and 1690 MHz. Return user uplink signal 130 can operate within a 48.5 MHz band, and therefore, the tapped reference return user uplink signal 330 can also operate within the same band. Forward user downlink signal 135 can operate within a 41 MHz band, and therefore, the tapped reference forward user downlink signal 335 also operates within the same band. Since the frequency bands of the three signals operate within different non-overlapping bands in between 1190 MHz and 1690 MHz, multiplexer 235 can put each of the signals on the same medium (as indicated by the shadings) while preserving the data provided by the signals. That is, each of the signals can generally be provided at a similar time to channelizer 205 since they are operating within separate frequency bands.

Channelizer 205 can digitally de-multiplex the signals received from multiplexer 235 and analyze them. Accordingly, in FIG. 3, channelizer 205 receives return user uplink signal 130, reference return user uplink signal 330, forward user downlink signal 135, reference forward user downlink signal 335, and forward feeder uplink signal 120 on three input ports since reference return user uplink signal 330 and reference forward user downlink signal 335 are multiplexed upon the same input of channelizer 305 used by forward feeder uplink signal 120.

Channelizer 205 may analyze the de-multiplexed signals by determining differences between the phases and amplitudes of return user uplink signal 130 and forward user downlink signal 135 with their corresponding reference signals used as calibration signals (to compare). The reference signals can be provided to multiplexer 235 and multiplexed onto the same input as forward feeder uplink signal 120, as previously discussed. Channelizer 205 can then extract the signals and determine offsets that can be used to generate beamforming coefficients. The offsets can be determined one pair-at-a-time (i.e., one signal from a signal input module 220a-d, one signal from signal output module 230a-d).

For example, as previously discussed, the differences in the signals allowing for offsets may occur as satellite 105 ages and active components degrade. However, since the calibration path includes switches 225a and 225b, which are electromechanical switches (i.e., passive components rather than active components), the calibration paths from the test couplers to switches 225a and 225b may not vary much during the lifetime of satellite 105. By contrast, the paths between the inputs of channelizer 205 and the antenna feeds of signal input modules 220a-d might vary due to active components in the paths, as well as the paths between the outputs of channelizer 205 and the antenna feeds of signal output modules 230a-d. Accordingly, the tapped reference signals can be used as calibration signals to compare with the signals they are tapped from to determine offsets for the phases and amplitudes and used to determine beamforming coefficients.

Additionally, channelizer 205 can determine offsets for the phases and amplitudes of its inputs to its outputs to account for internal offsets as it routes signals since it may also degrade over time. Accordingly, channelizer 205 can determine a set of amplitude and phase offsets for each signal input module 220a-d to inputs of channelizer 205 (i.e., the receive stage), each input to each output of channelizer 205 (i.e., internally within channelizer 205), and each output of channelizer 205 to signal output modules 230a-d (i.e., the output stage) that can be used to determine beamforming coefficients.

For example, when channelizer 205 has determined all of the offsets for the phases and amplitudes, it can transmit data including the offsets to a ground station for determining beamforming coefficients based on the offsets since calculating the beamforming coefficients can be computationally intensive. When the ground station has determined the beamforming coefficients, it can provide the corresponding data to channelizer 205 such that it can update beamforming coefficient data on its end (e.g., stored in a beamforming table or matrix on a storage device) for use when providing forward user downlink signals 135. In other implementations, satellite 105 may determine the beamforming coefficients rather than transmitting the offsets to the ground station and receiving the beamforming coefficients from the ground station.

Accordingly, a forward user downlink signal 135 can be generated and transmitted (at the antenna feeds of a signal output module, such as signal output module 230a) with proper amplitude and phase via beamforming by using the beamforming coefficients such that characteristics of the signal at the ground (e.g., signal strength, data capacity, etc.) can be improved, for example, by taking into account all of the offsets. That is, channelizer 205 can use the beamforming coefficients to adjust the signals it provides at its outputs such that when the antenna feeds receive and transmit the signal, it has been beamformed to take into account the offsets that were previously determined.

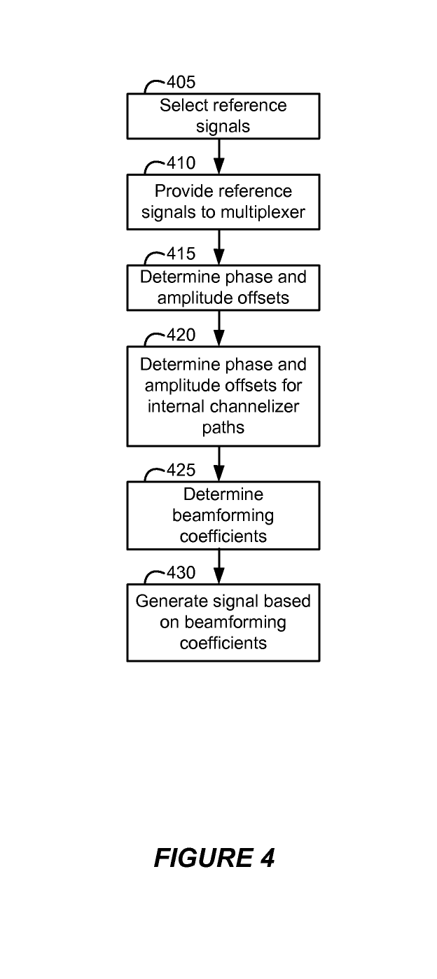

In additional detail, FIG. 4 is an example of a flowchart for determining beamforming coefficients. In FIG. 4, at block 405, a pair of a reference return user uplink signal and a reference forward user downlink signal can be selected by switches to be provided to a multiplexer. For example, as previously discussed, switch 225a can select reference return user uplink signal 330 and switch 225b can select reference forward user downlink signal 335 tapped from signal input module 220a and signal output module 230a as in FIG. 3, respectively. In some implementations, channelizer 205 can be configured to calibrate the beamforming coefficients (e.g., every six months, or when instructed by a ground control station) by determining offsets for phases and amplitudes, and therefore, generates signals to be provided to switches 225a and 225b to select specific inputs to be provided to multiplexer 235.

At block 410, the selected reference return user uplink signal 330 and reference forward user downlink signal 335 can be frequency multiplexed by multiplexer 235 with forward feeder uplink signal 120. The output of multiplexer 235 can be provided to a single input of channelizer 205, as previously discussed.

At block 415, channelizer 205 can determine differences between the phases and amplitudes of return user uplink signal 130 with reference return user uplink signal 330. Additionally, channelizer 205 can determine differences between the phases and amplitudes of forward user downlink signal 135 and reference forward user downlink signal 335.

For example, the relationship between the phases and amplitudes can be expressed as Aₑe^{iφ}^{ₙ}*A_{ref}e^{iφ}^{_{ref}}=A_{Δn}e^{iφ}^{_{Δn}}, where Aₙe^{iφ}^{ₙ} represents the amplitude (as Aₙ) and phase (as e^{iφ}^{ₙ}) of return user uplink signal 130 from the antenna feed of signal input module 220a, A_{ref}e^{iφ}^{_{ref}} represents the amplitude and phase of reference return user uplink signal 330 received at channelizer 205 from multiplexer 235, A_{Δn}e^{iφ}^{_{Δn}} represents the differences of the amplitude and phase, or offsets, between return user uplink signal 130 and reference return user uplink signal 330, and n represents an integer as an identifier associated with the signal (e.g., if there are 120 inputs, then n is an integer from 1 to 120). In effect, by determining the amplitude and phase offsets, a return user uplink signal 130 received at an input of channelizer 205 along with the offsets can derive return user uplink signal 130 when it is received at the antenna feed of a signal input module 220a-d in order to account for the phase and amplitude changes caused by active components between the antenna feeds of signal input modules 220a-d and channelizer 205.

Likewise, channelizer 205 can determine differences between the phases and amplitudes of forward user downlink signal 135 with reference forward user downlink signal 335. As a result, channelizer 205 can determine offsets for the amplitudes and phases for a pair of input path and output path and store data indicating the offsets in memory within satellite 105. For example, a first set of data can include the phase and amplitude offsets for the input path of signal input module 220a, and a second set of data can include the phase and amplitude offsets for the output path of signal output module 230a. When the offsets for the first pair are completed, channelizer 205 can assert signals provided to switches 225a and 225b so that they switch to the next pair of reference signals to be analyzed with their corresponding return user uplink signal 130 and forward user downlink signal 135.

At block 420, channelizer 205 can also determine differences between the phases and amplitudes of signals as they are routed internally within itself from its inputs to its outputs. That is, phase and amplitude offsets for internal paths within channelizer 205 (i.e., from each input to each output of channelizer 205) can be determined by the channelizer itself through an internal digital processor time-base reference, which can be a built-in function of channelizer 205. The internal pathway auto-calibration is performed periodically by the channelizer and it can be independent of the external path calibrations that are described herein.

At block 425, the offsets can be used to determine beamforming coefficients. For example, satellite 105 can receive instructions from a control station to provide the offsets by downlinking data indicating the offsets that were determined by channelizer 205. The control station can compute beamforming coefficients based on the offsets and transmit data including the beamforming coefficients to satellite 105. Satellite 105 can then store the beamforming coefficients data on a storage medium. In some implementations, satellite 105 can determine the beamforming coefficients by itself.

In general, the relationship between the beamforming coefficients and the signals can be expressed as Aₙᵣe^{iφ}^{ₙᵣ}*A_{Δn}e^{iφ}^{_{Δn0}}*A_{Δn1}e^{iφ}^{_{ref}}*A_{Δn2}e^{iφ}^{_{Δn2}}*BF=Aₙₜe^{iφ}^{_{Δnt}}, where Aₙᵣe^{iφ}^{ₙᵣ} represents the phase and amplitude of a signal at the antenna feed or repeater input, A_{Δn0}e^{iφ}^{_{Δn0}} represents the phase and amplitude offsets of the input path (i.e., between the antenna feed of the signal input module and the input of channelizer 205), A_{Δn1}e^{iφ}^{_{ref}} represents the phase and amplitude offsets of the internal routing path within channelizer 205, A_{Δn2}e^{iφ}^{_{Δn2}} represents the phase and amplitude offsets of the output path (i.e., between the output of channelizer 205 to the antenna feed of the signal output module), BF represents the theoretical beamforming coefficient vectors without any phase and amplitude offsets caused by aging, and Aₐₜe^{iφ}^{_{Δnt}} represents the forward user downlink signal 135 provided at the output of channelizer 205 that is adjusted by the beamforming coefficients BF with offsets (i.e. the fully calibrated signal generated at the output of channelizer 205).

Accordingly, at block 430, channelizer 205 can generate forward user downlink signal 135 at amplitudes and phases that are adjusted based on beamforming coefficients BF and offsets such that when the generated forward user downlink signal 135 is transmitted at the antenna feeds of the signal output module corresponding to the output port of channelizer 205 the signal is beamformed to a narrow spot beam to increase the data transmission when it is received at a user terminal. For example, based on the combination of the signal input module 220a-d that provides the signals to an input of channelizer 205, the routing from the input of channelizer 205 to the output of channelizer 205, and which signal output module 230a-d is to receive the signals generated at the output of channelizer 205, beamforming coefficients can be looked up (e.g., in a lookup table (LUT), matrix, or other type of data structure stored in memory that is accessible by channelizer 205) and used by channelizer 205 when generating forward user downlink signal 135.

Thus, techniques have been disclosed, wherein a calibration system determines beamforming coefficients used to form a user spot beam. The foregoing merely illustrates principles of the invention. It will thus be appreciated that those skilled in the art will be able to devise numerous systems and methods which, although not explicitly shown or described herein, embody said principles of the invention and are thus within the spirit and scope of the invention as defined by the following claims.

What is claimed is:

1. An apparatus comprising:
a spacecraft communications subsystem including:
a channelizer;
a set of input components configured to provide a plurality of return user uplink signals to the channelizer, each of the set of input components including a corresponding test coupler configured to provide reference return user uplink signals;
an input switch configured to receive each of the reference return user uplink signals;
a set of output components configured to receive a plurality of forward user downlink signals from the channelizer, each of the output components including a corresponding test coupler configured to provide reference forward user downlink signals;
an output switch configured to receive each of the reference forward user downlink signals; and
a multiplexer having a first input to receive a feeder link signal, a second input to receive one of the reference return user uplink signals from the input switch as a selected reference return user uplink signal, a third input to receive one of the reference forward user downlink signals from the output switch as a selected reference forward user downlink signal, and an output providing the feeder link signal, the selected return user uplink signal, and the selected reference forward user downlink signal to the channelizer, wherein the channelizer is configured to:
determine amplitude and phase offsets of the selected reference return user uplink signal with the corresponding return user uplink signal, and
determine amplitude and phase offsets of the selected reference forward user downlink signal with the corresponding forward user downlink signal.

2. The apparatus of claim 1, wherein each of the forward user downlink and the return user uplink signals are live traffic signals to and from ground devices, respectively.

3. The apparatus of claim 1, wherein the channelizer includes inputs to receive the return user uplink signals and outputs to provide the forward user downlink signals, and the channelizer is further configured to determine amplitude and phase offsets for each path between the inputs and the outputs.

4. The apparatus of claim 3, wherein the spacecraft communications subsystem is configured to transmit the amplitude and phase offsets to a control station, and wherein the spacecraft communications subsystem is configured to receive corresponding beamforming coefficients from the control station for adjusting phases and amplitudes of signals generated at the outputs of the channelizer.

5. The apparatus of claim 1, wherein the feeder link signal, the selected reference return user uplink signal, and the selected reference forward user downlink signal are associated with separate frequency bands.

6. The apparatus of claim 5, wherein the separate frequency bands are non-overlapping.

7. The apparatus of claim 1, wherein each component in calibration paths providing the reference forward user downlink signals and the reference forward user downlink signal is passive.

8. The apparatus of claim 7, wherein the set of input components and the set of output components include active components.

9. The apparatus of claim 1, wherein the input switch and the output switch are electromechanical switches.

10. The apparatus of claim 1, wherein the channelizer is further configured to configure the input switch to provide each of the reference return user link signals to the multiplexer and the output switch to provide each of the reference forward user link signals to the multiplexer, the signals provided to the multiplexer in pairs, each pair including one signal provided by the input switch and one signal provided by the output switch.

11. An apparatus comprising:
a digital channelizer of a spacecraft communications subsystem, the digital channelizer being configured to determine phase and amplitude differences of a return user uplink signal with a corresponding reference user uplink signal, and phase and amplitude differences of a forward user downlink signal with a corresponding reference forward user downlink signal, the digital channelizer being further configured to receive the reference user uplink signal and the reference forward user downlink signal frequency-division multiplexed with a forward feeder link signal.

12. The apparatus of claim 11, wherein the forward user downlink signal and the return user uplink signal are live traffic signals to and from ground devices, respectively.

13. The apparatus of claim 11, wherein the digital channelizer is further configured to determine amplitude and phase differences of signals for each path between its inputs and outputs.

14. The apparatus of claim 11, wherein the amplitude and phase differences are used to determine beamforming coefficients for signals generated at outputs of the digital channelizer.

15. The apparatus of claim 11, wherein the forward feeder link signal, the reference return user uplink signal, and the reference forward user downlink signal are associated with separate frequency bands.

16. The apparatus of claim 14, wherein the separate frequency bands are non-overlapping.

17. The apparatus of claim 11, wherein the digital channelizer is further configured to select the reference forward user downlink signal and the reference return user uplink signal to be frequency-division multiplexed with the forward feeder link signal.

18. A method comprising:
selecting, by a spacecraft communications subsystem, a reference return user uplink signal corresponding to a return user uplink signal, the reference return user uplink signal provided on a first calibration path having passive components, the return user uplink signal provided on an input path having active components;
selecting, by the spacecraft communications subsystem, a reference forward user downlink signal corresponding to a forward user downlink signal, the reference forward user downlink signal provided on a second calibration path having passive components, the forward user downlink signal provided on an input path having active components;
multiplexing, by the spacecraft communications subsystem, the reference return user uplink signal and the reference forward user downlink signal with a forward feeder uplink signal such that the reference return user uplink signal, the reference forward user downlink signal, and the forward feeder uplink signal are in separate frequency bands; and
determining, by the spacecraft communications subsystem, phase and amplitude offsets between the multiplexed reference return user uplink signal and the return user uplink signal, and phase and amplitude offsets between the multiplexed reference forward user downlink signal and the forward user downlink signal.

19. The method of claim 18, the method further comprising:
transmitting, by the spacecraft communications subsystem, the phase and amplitude offsets;
receiving, by the spacecraft communications subsystem, beamforming coefficients corresponding to the phase and amplitude offsets; and
generating, by the spacecraft communications subsystem, a second forward user downlink signal with a phase and an amplitude based on the beamforming coefficients.

20. The method of claim 19, wherein the spacecraft communications subsystem includes a channelizer having an input to receive the return user uplink signal, an output to provide the forward user downlink signal, and a feeder input to receive the multiplexed reference return user uplink signal, the reference forward user downlink signal, and the forward feeder uplink signal.
